(19) United States
(12) Patent Application Publication
(10) Pub. No.: US 2003/0111560 A1
(43) Pub. Date: Jun. 19, 2003

(54) High pressure seal

(76) Inventors: David R. Bartkowiak, Normal, IL (US); Dale C. Maley, Fairbury, IL (US)

Correspondence Address: CATERPILLAR INC., 100 N.E. ADAMS STREET, PATENT DEPT., PEORIA, IL, 616296490

(21) Appl. No.: 10/023,562

(22) Filed: Dec. 18, 2001

(51) Int. Cl. F02M 59/00

(52) U.S. Cl. 239/533.9; 138/143; 138/155; 138/109; 239/533.3; 239/584; 239/88; 239/600

(57) ABSTRACT

An high pressure seal comprises a tube with a first end adapted to fit into a first bore of a first mating part and a second end adapted to fit into second bore of a second bore of a second mating part and allow fluid communication between the first bore and the second bore. The seal is expandable radially about an axis to form a seal between the first and second mating parts.

### TECHNICAL FIELD

The present invention relates to high pressure seal between two mating parts.

### BACKGROUND

Proper sealing is vital in the use of products carrying high pressure fluids. For example, engine systems must carry high pressure fluid, either actuation fluid or fuel, in order to achieve necessary injection pressures. This places a great demand on the design of the fuel injector in particular. The fuel injector must be able handle these high pressure fluids without leaking or risk engine damage and reduced efficiencies.

Many types of seals currently exist, including the use of o-rings, face seals, and threaded connections; however improvement is still necessary as fluid pressures continue to increase and cost restraints require reduced parts, greater performance, and manufacturing ease.

The present invention is directed to overcoming one or more of the above problems.

### SUMMARY OF THE INVENTION

In the first embodiment of the present invention a high pressure seal between a first mating part and a second mating part comprises a tube having an outer surface and inner surface defining a hollow bore ring through the tube along a first axis. The bore begins at a first end of the tube and ends at a second end. The first end of the tube is adapted to fit into a first bore of a first mating part and the second end of the tube is adapted to fit into a second bore of the second mating part. The tube the seal is expandable radially about the first axis by pressurized fluid flowing through the hollow bore and causing the tube to form a seal between first and second mating part.

In the second embodiment of the present invention, a fuel injector comprises a lower outer body, a tip at least partially disposed within said lower body an having an inner surface and outer surface, and at least one orifice disposed within the tip allowing communication between the inner an outer surface, fuel passage is disposed within the tip incapable of communication with the orifice, a needle valve at least partially disposed in the tip and being movable between the first position at which communication between the orifice and the fuel passage is closed and a second position at which communication between orifice and the fuel passage is opened, an upper body connected to the lower body, the upper body having a bore an a plunger at least partially disposed within the bore, a fuel pressurization chamber at least partially defined by the bore and the plunger, a cartridge valve assembly connected to the upper body, a first fluid bore in the upper body and a second fluid bore in cartridge valve assembly an a high pressure seal connecting the first fluid bore to the second fluid bore. The high pressure seal has an outer surface and a hollow bore ring through the tube along the first axis in defining an inner surface. The bore beginning at a first end of the tube and ending at a second end wherein the first end is adapted to fit into the first fluid bore and the second end is adapted to fit into the second end fluid bore and allow fluid communication between the first and second bores. The tube is expandable radially about the first axis by pressurized fluid within the bore causing the tube to form a seal between the first and second fluid bores.

In the third embodiment, a method of sealing a first mating part to a second mating part comprises inserting a first end of the seal into a first bore of the first mating part, inserting a second end of the seal into a second bore of the second mating part, introducing pressurized fluid into the seal, and expanding the seal radially about an axis to form seal between the first mating part and the second mating part.

### BRIEF DESCRIPTION OF THE DRAWINGS

FIG. 1 is diagrammatic cross section of a fuel injector according to one embodiment of the present invention.

FIG. 2 is a diagrammatic isometric view of one embodiment of the present invention.

### DETAILED DESCRIPTION

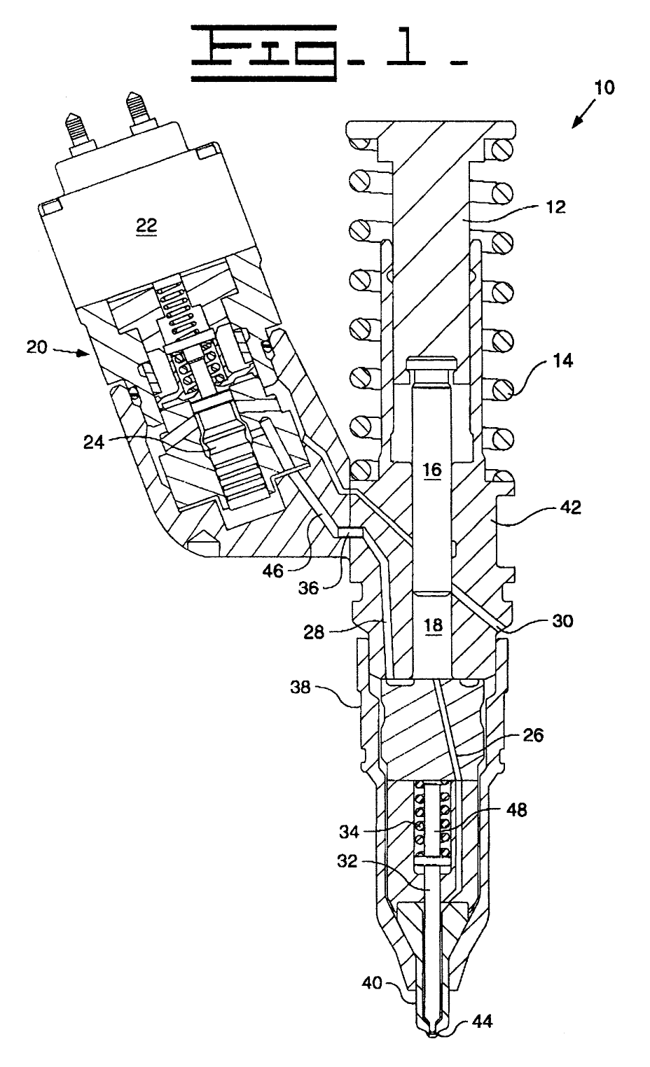

FIG. 1 is a diagrammatic cross section of a electronic unit injector 10. The fuel injector 10 comprises an upper body 42 that includes a tappet 12, biased in the upper position by tappet return spring 14, to actuate plunger 16 in order to pressurize fuel within pressurization chamber 18. The tappet 12 is actuated by a roller (Not Shown) attached to the cam shaft (Not Shown). Low pressure fuel is introduced into pressurization chamber 18 through an inlet (Not Shown). Low pressure fuel is pressurized as tappet 12 and plunger 16 are moved in a downward position by a roller (Not Shown).

Pressurized fuel from pressurization chamber 18 is then sent in two directions: first, pressurized fuel is sent through the lower body 38 of injector 10 via a first pressurized fuel line 26 toward the tip 40 of injector 10. Within the lower body of the injector 38, a check valve 48 prevents the flow of unpressurized fuel through orifice 44 into the combustion chamber (Not Shown). The check valve 48 includes a check 32 and a check spring 34, which biases check 32 in the downward or closed position. When high pressure fuel is introduced into the tip via first pressurized fuel line 26, the high pressure fuel acts on the check 32, pushing it in the upward or open direction against the force of check spring 34, thereby allowing injection of pressurized fuel through the orifice 44. Pressurized fuel from pressurization chamber 18 is also sent through a second pressurized fuel line 28 to cartridge valve pressure line 46 in cartridge valve 20.

In moving through second pressurized fuel line 28 to cartridge valve pressure line 46, the pressurized fuel passes through high pressure seal 36. High pressure seal 36 is a tube inserted partially into each pressure line 28 and 46.

Cartridge valve 20 contains a spill valve 24 which is actuated by solenoid 22. When spill valve 24 is in a first position, pressurized fuel is allowed to communicate with low pressure line 30 and spill back to tank. When spill line 30 is opened, first pressurized fuel line 26 is open to a low pressure dump, preventing pressure from actually building within the tip of the injector and forcing check 32 into the upper, open position. Therefore, when the spill valve is opened, injection does not occur.

When solenoid 22 is energized, moving spill valve 24 to a second position, spill line 30 is blocked causing a buildup in pressure in second pressurized fuel line 28 and first pressurized fuel line 26. The buildup of pressure in first pressurized fuel line 26 causes check 32 to move upward, into its open position, and allowing injection. Therefore, by controlling the position spill valve 24 in cartridge valve 20, the timing and duration of injection can be controlled even though pressurization is preformed mechanically, at a predetermined time based upon the shape of the cam shaft and the speed of the engine.

### INDUSTRIAL APPLICABILITY

Sealing between components or mating parts is very important for efficient and proper operation. As illustrated in FIG. 1, a second high pressure fuel line 28 runs from the pressurization chamber 18 in upper body 42 to cartridge valve pressure line 46 located in cartridge valve 20. In order to insure proper sealing, between these two pieces, it is necessary for high pressure seal 36 be inserted into second high pressure fuel line 28 and cartridge valve pressure line 46.

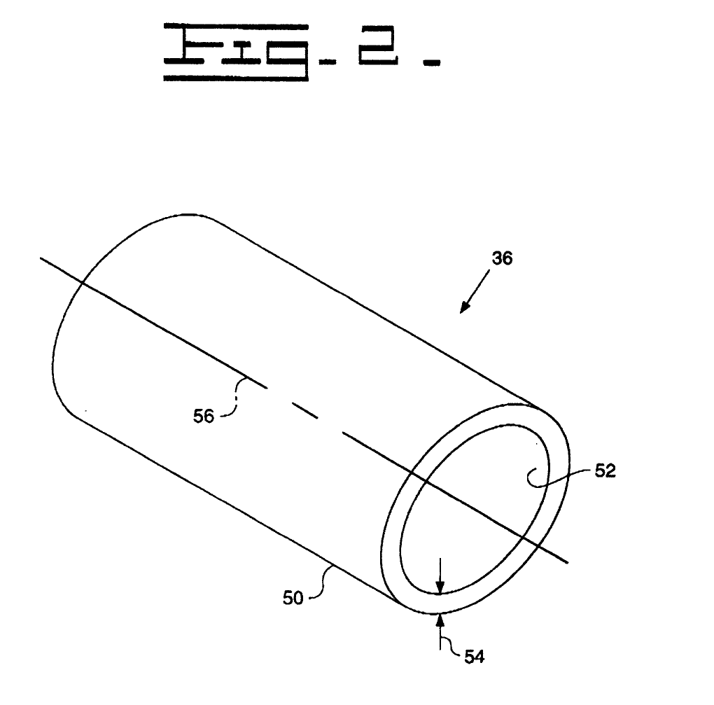

High pressure seal 36, as generally illustrated in FIG. 2, can be of a tubular shape in which a first end inserts into second pressurized fuel line 28 and a second end inserts into CCV pressure line 46. Preferably, high pressure seal 36 is clearance fit on one side, such as the upper body 42, and press fit on the other side, such as the cartridge valve 20. Additionally, it is preferable that seal 36 is completely encompassed by the bores it is trying to seal. In other words, the mating parts abut against each other.

During start up or low pressures, often as low as 95 PSI, seal 36 acts as a conduit for fluid between the two mating parts but is not required to perform as a high pressure seal because fluid pressures are not sufficient to cause excessive leakage between the outer surface 50 and the wall 58 of the high pressure line. (Note that only one pressure line wall has been called out but that all pressure lines have a wall defining the fluid passage.) As pressure increases, tighter sealing becomes necessary. During peak injection, pressures can exceed 22,000 PSI. These types of pressures require a tighter seal between outer surface 50 and wall 58. In order to obtained an adequate seal, high pressure seal 36 expands radially about its center axis 56, preventing high pressure fuel from leaking between the outer surface 50 of the high pressure seal 36 and a wall 58 of the high pressure line, in this case second pressurized fuel line 28 and cartridge valve pressure line 46. Once seal 36 expands radially, forming tight seal with wall 58, expansion may also occur longitudinally, providing additional sealing surface. When high pressure seal 36 expands, a tight fit is formed, between the seal 36 and wall 58 of the pressure lines 28 and 46, allowing high pressure fluid communication between the two pressure lines 28 and 46 through seal 36. Seal 36 also preferably has a smooth surface finish to further create a tight seal and reduce possible leakage.

During operation, as stated above, seal 36 is exposed to a wide range of pressures, but it is important to specifically point out two phenomena that the seal 36 must withstand. First, when spill valve 24 is open, allowing pressure to vent through low pressure line 30, a vacuum affect is created pulling the pressurized fuel from pressurization chamber 18 through upper body 42, via second pressurization line 28 through seal 36 into cartridge valve pressure line 46. Therefore, seal 36 is exposed to particular pressure coming from the upper body 42. Second, when spill valve 24 is closed, a “water hammer” effect is created, causing a pressure spike in the opposite direction of the original fluid flow, moving from cartridge valve pressure line 46 to seal 36 and into second pressure line 28. In this scenario, seal 36 “sees” or is exposed to additional pressure from the cartridge valve side.

In designing high pressure seal 36, many variables may need to be considered, including the material used to make the seal 36, the thickness 54 of the seal 36, the potential pressures, and the amount of radial expansion needed to create an adequate seal. When picking the material, specific attention must be paid to the elasticity of the material. The elasticity will define the materials rate of expansion, based upon the pressure, and the needed thickness of the material. Additionally, the elasticity will determine if the seal permanently deforms or returns to its original size and shape when the high pressure is removed. A variety of materials could be used for the seal, including metallic materials, such as 4140 modified steel. The thickness 54 of seal 36, defined as the distance between the inner surface 52 and outer surface 50, will depend on the type and size of usage. In the present example, in a fuel injector, the thickness is preferably about 992 microns but the thickness could be more or less depending on the desired use. In any case, the thickness 54 must be appropriate to allow proper radial expansion.

The high pressure seal 36, disclosed above, can be used in a variety of applications other than fuel injectors, providing a seal between two mating parts communicating fluid. Those skilled in the art will appreciate that other aspects, objects and advantages of this invention can be obtained from a study of the drawings, disclosure, and claims.

What is claimed is:

1. A high pressure seal between a first mating part and a second mating part, the seal comprising:
a tube having an outer surface and an inner surface defining a hollow bore running through said tube along a first axis;
said bore beginning at a first end of said tube and ending at a second end;
said first end of said tube being adapted to fit into a first bore of said first mating part and said second end of said tube being adapted to fit into a second bore of said second mating part, said hollow bore allowing fluid communication between said first bore of said first mating part and said second bore of said second mating part; and
said tube being expandable radially about said first axis by a pressurized fluid within said hollow bore and causing said tube to form a seal between said first and second mating parts.

2. The high pressure seal of claim 1 wherein said tube expands longitudinally.

3. The high pressure seal of claim 1 wherein said tube is press fit into said first bore.

4. The high pressure seal of claim 1 wherein said tube is clearance fit into said second bore.

5. The high pressure seal of claim 1 having a thickness defined by a distance between said outer surface and said inner surface of approximately 1 millimeter.

6. The high pressure seal of claim 1 having a thickness defined by a distance between said outer surface and said inner surface of less than 1 millimeter.

7. The high pressure seal of claim 1 wherein said seal is exposed to pressures in excess of 20,000 PSI.

8. The high pressure seal of claim 1 wherein said seal has a smooth surface finish.

9. The high pressure seal of claim 1 wherein said seal is completely encompassed by said first and second mating parts.

10. A fuel injector comprising:
a lower outer body,
a tip at least partially disposed within said lower body and having an inner surface and an outer surface;
an at least one orifice disposed within said tip and allowing communication between said inner surface an said outer surface;
a fuel passage disposed within said tip and capable of communication with said at least one orifice;
a needle valve at least partially disposed in said tip; said needle valve being moveable between a first position at which communication between said orifice and said fuel passage is closed and a second position at which communication between said orifice and said fuel passage is open;
an upper body connected to said lower body, said upper body having a bore;
a plunger at least partially disposed within said bore;
a fuel pressurization chamber at least partially defined by said bore and said plunger;
a cartridge valve assembly connected to said upper body;
a first fluid bore within said upper body;
a second fluid bore within said cartridge valve assembly;
a high pressure seal connecting said first fluid bore and said second fluid bore; said high pressure seal being a tube having an outer surface and a hollow bore running through said tube along a first axis and defining an inner surface; said bore beginning at a first end of said tube and ending at a second end; said first end of said tube being adapted to fit into said first fluid bore and said second end of said tube being adapted to fit into said second fluid bore and allowing fluid communication between said first fluid bore and said second fluid bore; said tube being expandable radially about said first axis by a pressurized fluid within said hollow bore and causing said tube to form a seal between said first and second fluid bores.

11. The high pressure seal of claim 10 wherein said tube expands longitudinally.

12. The high pressure seal of claim 10 wherein said tube is press fit into said first bore.

13. The high pressure seal of claim 10 wherein said tube is clearance fit into said second bore.

14. The high pressure seal of claim 10 having a thickness defined by a distance between said outer surface and said inner surface of approximately 1 millimeter.

15. The high pressure seal of claim 10 having a thickness defined by a distance between said outer surface and said inner surface of less than 1 millimeter.

16. The high pressure seal of claim 10 wherein said seal is exposed to pressures in excess of 20,000 PSI.

17. The high pressure seal of claim 10 wherein said seal has a smooth surface finish.

18. The high pressure seal of claim 10 wherein said seal is completely encompassed by said first and second mating parts.

19. A method of sealing a first mating part and a second mating part with a seal comprising a tube having an outer surface and an inner surface defining a hollow bore running through said tube along a first axis, said bore beginning at a first end of said tube and ending at a second end, the method comprising the steps of:
inserting said first end of said seal into a first bore of said first mating part;
inserting said second end of said seal into a second bore of said second mating part;
introducing pressurized fluid into said seal;
expanding said seal radially about said first axis with said pressurized fluid to form a seal between said first mating part and said second mating part.

20. The method of claim 19 further comprising the step of expanding said seal longitudinally.

21. The method of claim 19 wherein the step of inserting said first end further comprises the step of press fitting said first end of said seal into said first bore.

22. The method of claim 19 wherein the step of inserting said second end further comprises the step of clearance fitting said second end of said seal into said second bore.

23. The method of claim 19 further comprising the step of completely encompassing said seal in said first and second bores.
